(19) United States
(12) Patent Application Publication
(10) Pub. No.: US 2008/0191481 A1
(43) Pub. Date: Aug. 14, 2008

(54) Method for Production of a Plug Connection and a Plug Connection

(75) Inventor: Harald Hartmann, Dornbirn (AU)

Correspondence Address: NORRIS, MCLAUGHLIN & MARCUS, 875 THIRD AVE, 18TH FLOOR, NEW YORK, NY, 10022, US

(73) Assignee: HENN GMBH & CO. KG, Dornbirn (AU)

(21) Appl. No.: 11/587,298

(22) PCT Filed: Apr. 13, 2005
(86) PCT No.: PCT/EP05/03859

§ 371 Date: Nov. 30, 2006

(51) Int. Cl. F16L 37/088

(52) U.S. Cl. 285/344

(57) ABSTRACT

The invention relates to a method for production of a plug connection for a plug piece (1) with a connector (5), as a liquid and/or gas-tight connection, preferably in automobile assembly, whereby the plug piece (1) and the connector (5) are sealed relative to each other by means of a sealing ring (11) arranged in a L-shaped sealing ring groove (14), in particular, a moulded sealing ring. In a first method step the sealing ring (11) together with a securing ring (12) are introduced as a sealing unit (24) in the axial direction into the L-shaped sealing ring groove (14), open in the axial direction and a second method step, beads (13) are formed in the region of the radial defining wall of the L-shaped sealing ring groove (14), by means of a chasing tool (26), moving in the axial direction, with an mutual separation in the circumferential direction and which at least partly displace the L-shaped sealing ring groove (14) in the region of the axial opening thereof and thus fix the securing ring (12) on the one axial side thereof. A fixing of a formed sealing ring (11) in an L-shaped sealing ring groove (14) is improved, whereby the formed sealing ring (11) can be fixed in the position for assembly thereof with a particularly simple action using an easily assembled securing ring (12).

### BACKGROUND OF THE INVENTION

The invention relates to a method for producing a plug connection and a plug connection produced with the method according to the preamble of claim 1.

Plug connections of this type are used as liquid-tight and/or air-tight connections preferably in automobile construction. For example, a connection piece is formed on the radiator of a motor vehicle or of another type of land vehicle, aircraft or marine vessel, with a plug sealingly engaging with the connection piece so as to form a reliable connection.

The invention is not limited to the production of plug connections in the field of the vehicle construction, and also not to land vehicles, aircrafts or marine vessels. All water-tight and/or air-tight plug connections can be used.

A conventional plug connection of the aforedescribed type is described in a number of previous patent applications from the same applicant. Reference is made to the subject matter disclosed therein. The subject matter disclosed therein is meant to be encompassed by the present invention in its entirety.

The conventional plug connection consists essentially of a connection piece made of a plastic or metallic material, which has of its outer periphery one or more radially outwardly oriented sloped catches.

This connection piece is inserted into the interior space of a plug and interlocks with the plug by way of one or more catch springs. To provide a sealing connection, it is known to arrange in the interior space of the plug a packing cord which rests on an axial side of the connection piece on a corresponding outwardly oriented opposing surface.

To simplify the description, the following description assumes that a connection piece is inserted into the corresponding inner space of an outer plug. However, the invention is not limited to this embodiment. It can also to be kinematically reversed, wherein an interior plug is inserted into an outer connection piece. All subsequently described situations can therefore be modified by kinematic reversal.

One problem in the production of such plug connections lies in reliably positioning the sealing ring (profiled sealing ring) at the location wherein is to be secured and to protect the sealing ring at that location against tilting, deformation, jamming and the like. It is known to insert the profiled sealing ring into a corresponding sealing ring groove and to use an additional safety ring which holds the profiled sealing ring on at least one side. The sealing ring is then inserted by a press fit and secured.

It is also known to hold the safety ring for transport to the installation location with glue or solder to thereby secure the profiled sealing ring.

It is also known to provide a sealing ring groove with an overall U-shaped profile, wherein the U-profile is formed by a corresponding forming process in the region of the plug piece.

However, formation of such U-profiled grooves is a very complex process because of the more or less exact size requirements.

The invention is therefore based on a sealing groove with an L-shaped profile, i.e., the sealing groove is open on one of its axial sides. The safety ring is then to be inserted on this axial side.

It is the therefore an object of the invention to improve the installation of a profiled sealing ring in an L-shaped groove on the inside of a plug piece so that the profiled sealing ring can be secured in a particularly simple manner at the installation site with an easily installable safety ring.

### BRIEF SUMMARY OF THE INVENTION

For solving the aforedescribed object, the invention provides a method wherein in a first process step the sealing ring together with a safety ring, which has a flat, approximately rectangular profile, are inserted as a sealing unit in an axial direction into the L-shaped sealing ring groove which is open in the axial direction and disposed on the inside of the plug piece, and wherein in a second process step beads are produced by a pressing tool moving in the axial direction in the region of a radial boundary wall of the L-shaped sealing groove, wherein the beads are spaced from each other in the peripheral direction and at least partially displace the L-shaped sealing ring groove in the region of its axial opening so as to secure the safety ring on one axial side.

Certain cross-sections of the sealing ring groove, which previously were open on one side, at least at certain locations along the periphery, are then urged radially inwardly and thereby limit the axial play of the safety ring, which is then reliably held in the sealing ring groove in contact with the profiled sealing ring.

It is hence an important feature of the method of the invention that sections of the sealing ring groove can be deformed with a forming tool or—in another embodiment—with a punching tool, so that at least at certain locations along the periphery, portions of the sealing ring groove are urged into the L-cross-section of the sealing ring groove that is open in the axial direction, thereby securing the safety ring.

The L-shaped groove which was open on one side in the axial direction, is thereby transformed into an at least partially closed U-shaped profiled groove.

The radially inwardly oriented deformations (edge beads) thereby secure the safety ring in the sealing ring groove at various locations along the periphery and hence simultaneously also secure the profiled sealing ring.

Based on this technical teaching, the safety ring can advantageously be formed with complete rotational symmetry and may not have any openings or recesses or require additional machining.

The plug piece is then also completely rotationally symmetric and can be easily manufactured. No transverse operations or undercuts are required.

The plug piece therefore also does not require an axial limit stop for the safety ring, which facilitates manufacturing of the plug piece and reduces the length.

The sealing ring is installed in the peripheral sealing ring groove slightly prestressed and without play independent of the tolerances and is held in place by the safety ring. This provides a completely reliable installation process of the plug piece and the connection piece in the manufacturing plant, because there is no longer a risk for the profiled sealing ring to come loose, to tilt or to undergo an undesirable deformation.

Matching the tolerances of the individual components (sealing ring groove, profiled sealing ring and safety ring) is also significantly simplified. The safety ring can be made very thin and does not require tight diameter tolerances, as would otherwise be required with a press fit.

This has the advantage that the safety ring can also be produced using other manufacturing methods, for example coiling or bending. This saves material and production costs.

The sealing unit is installed and the sealing ring groove is pinched in a single axial assembly direction. Costly, installation steps and processes in the opposite direction are hereby eliminated.

The connection requires very little space, because a sealing ring with a very small cross-section can be used. Pairs of different materials can be used for the plug piece to be formed and the safety ring, whereby the plug piece undergoes a permanent plastic deformation due to the applied edge beads.

The subject matter of the invention is not only based on the features recited in the individual claims, but also combinations of the various claims.

All information and features disclosed in the application, including the abstract, in particular the three-dimensional arrangement depicted in the drawings, are part of the claimed invention, as long as they are novel in view of the prior art, either individually or in combination.

### BRIEF DESCRIPTION OF THE DRAWINGS

The invention will be now described in more detail with reference to the drawings which only depict one exemplary embodiment. Additional inventive features and advantages of the invention can be inferred from the drawings and their description.

It is shown in:

FIG. 1: a perspective view of a plug connection (partially open) with an inserted sealing unit;

FIG. 2: an enlarged cross-sectional view through the plug piece of the plug connection according to FIG. 1 before edge beads are produced;

FIG. 3: the same diagram as FIG. 2 after the edge beads are produced;

FIG. 4: a perspective view of the plug connection before installation of the sealing unit.

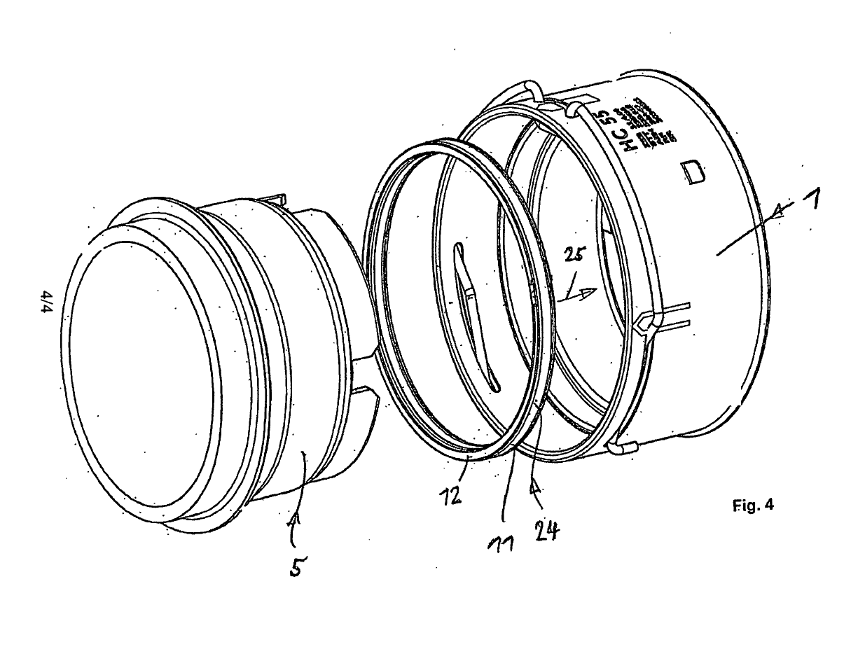

### DETAILED DESCRIPTION OF THE INVENTION

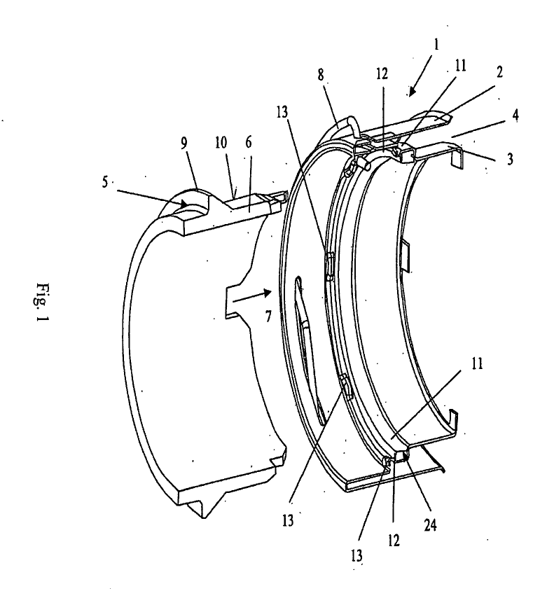

As shown in FIG. 1, a plug piece 1 consists of an outer sleeve 2 which is made of the same material and connected as one piece with the inner sleeve 3. The two components can also be formed without a material connection; however, in the depicted exemplary embodiment, they are connected with each other. The two sleeves 2, 3 form between them a receiving space 4 adapted to receive a hose which is sealingly secured thereto.

Alternatively, the plug piece 1 and the connected hose can also formed as a single piece from the same material.

The plug piece 1 interlocks in a known manner with the connection piece 5 which for this purpose has on its outer periphery a radially outwardly protruding sloped catch 9 and a side section 6 which extends from the sloped catch towards the front in the axial direction and forms an outer radial sealing surface 10.

The plug connection is established, for example, by inserting the connection piece 5 into the interior space of the plug piece 1 in the direction of arrow 7, whereby the illustrated catch spring 8 engages behind of the sloped catch 9 of the connection piece 5.

The snap-in connection is thereby established, and a sealing connection is produced in the interior space of the plug piece 1 (in the region of the inner sleeve 3) by a profiled sealing ring 11 which sealingly contacts with its protruding elastomer cross-sections the sealing surface 10 of the connection piece 5.

Importantly, the sealing connection is established by a sealing unit 24, which is defined by the aforementioned profiled sealing ring 11 in connection with a safety ring 12 contacting the profiled sealing ring 11 in the axial direction.

According to the method of the invention, this sealing unit 24 is secured in a particularly simple and reliable manner in the interior space of the inner sleeve 3 in the region of the circumferential sealing ring groove 14 against axial movement, tilting and jamming.

For this purpose, edge beads 13 are shaped from certain cross-sections in the region of the inner sleeve 3, wherein the edge beads 13 partially close the pre-machined, approximately L-shaped profiled sealing ring groove 14 which is open in the axial direction along the periphery, thereby forming a sealing ring groove 14 with a partial U-shaped profile.

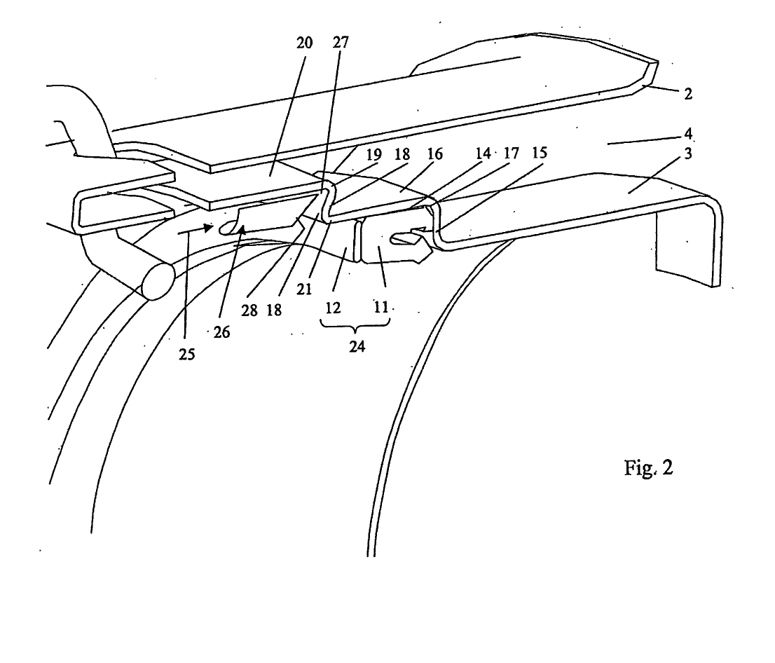

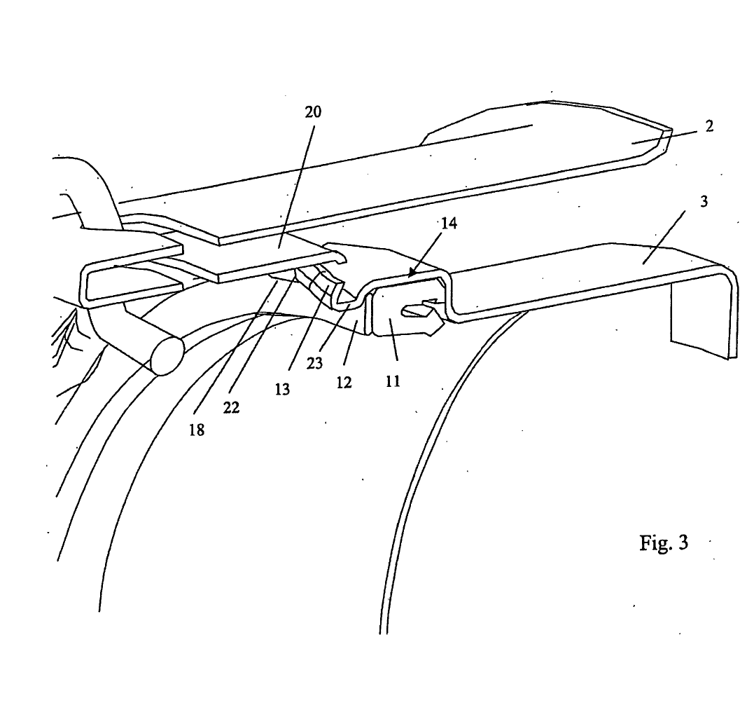

Details of this method can be seen from a comparison between FIG. 2 and FIG. 3.

It is evident that the sealing ring groove 14 is formed by a radial side section 15 which transitions via a bent section 17 into the following axial side section 16.

The axial side section 16 forms a protuberance 21 in the axial direction with a length that is significantly greater than the axial length of the profiled sealing ring 11 and the adjacent safety ring 12.

Starting from this protuberance 21, a side section 18 formed following a bent section has preferably a slight angle with respect to the radial direction.

However, the invention is not limited to this embodiment, as the side section 18 may also be oriented exactly in the radial direction.

The side section 18 is followed by a bent section 19 and then an axial side section 20.

Importantly, the sealing unit 24 which consists of the safety ring 12 and the profiled sealing ring 11 is secured by a pressing tool 26 in the sealing ring groove 14 against displacement and a change in position.

A pressing tool 26 is hereby moved in the direction of arrow 25 against the side section 18.

The pressing tool 26 has, when viewed in the operating direction, a front cutting edge 27 which preferably penetrates the material of the side section 18 where it produces an opening 22 (FIG. 3). After the opening 22 is produced, the sloped surface 28 of the pressing tool 26 arranged in the axial direction 25 following the cutting edge 27 displaces the material of the shaped edge beads 13 radially inwardly, thereby producing a bent section 23 which is bent inwardly in the radial direction.

As shown in FIG. 3, this bent section 23 limits the rearward position of the safety ring 12 in the axial direction and thereby secures the safety ring 12 together with the profiled sealing ring 11 against displacement and a change in position.

It should be noted that the pressing tool 26 does not need to produce the openings 22 required for the solution.

In another embodiment, a deformation may only be produced by deforming parts of the side section 18 radially inwardly, as shown in FIG. 3, without creating openings 22.

Preferably, the edge beads 13 formed by the pressing tool 26 in the region of the side section 18 are distributed uniformly along the periphery. However, the invention is not limited to this arrangement.

By providing edge beads 13 on one wall of the safety ring 12, the safety ring 12 can be installed slightly prestressed, without play, and independent of tolerances that exist in the region of the sealing ring groove 14.

The profiled sealing ring 11 thus forms the counter support for the pressing tool and is therefore also prestressed when urged into the sealing ring groove 14. As a result, large tolerances that may occur during the fabrication of the sealing ring groove 14 can be compensated.

The profiled sealing ring is also secured so as to prevent it from being tilted or removed from the plug piece at the installation site in other ways or from falling out.

The sealing unit 24 is hence non-detachably integrated in the plug piece 1.

### LIST OF REFERENCE SYMBOLS

1 plug piece
2 outer sleeve
3 inner sleeve
4 receiving space
5 connection piece
6 side section
7 direction of arrow
8 catch spring
9 sloped catch
10 sealing surface
11 profiled sealing ring
12 safety ring
13 edge bead
14 sealing ring groove
15 side section
16 side section
17 bent section
18 side section
19 bent section
20 side section
21 protuberance
22 opening
23 bent section
24 sealing unit
25 direction of arrow
26 pressing tool
27 cutting edge
28 sloped surface

1. A method for providing a plug connection between a plug piece and a connection piece in form of a fluid-tight and/or air-tight connection,
comprising the steps of
providing a plug piece and a connection piece sealed against each other through a profiled sealing ring and disposed in an L-shaped sealing ring groove,
inserting the sealing ring together with a safety ring as a sealing unit in an axial direction into the L-shaped sealing ring groove which is open in the axial direction, and
producing beads by a pressing tool moving in the axial direction in a region of a radial boundary wall of the L-shaped sealing groove, wherein the beads are spaced from each other in peripheral direction and at least partially displacing the L-shaped sealing ring groove in a region of its axial opening so as to secure the safety ring (12) on one axial side.

2. The method according to claim 1, wherein the plug piece and the connection piece interlock with one another, with the help of one or several catch springs disposed on the plug piece or the connection piece, for contacting a sloped catch disposed on the connection piece or the plug piece.

3. The method according to claim 1, wherein the inner connection piece is inserted into an interior space of the outer plug piece and the sealing ring groove is formed on the inside of the plug piece.

4. The method according to claim 1, wherein the sealing ring is installed, independent of tolerances in the peripheral sealing ring groove, without play with a small pretension and is held in place by the safety ring.

5. The method according to claim 1, wherein the sealing unit is installed and the sealing ring groove is pinched in only one axial assembly direction.

6. A plug connection between a plug piece and a connection piece, forming a fluid-tight and/or air-tight connection, comprising a plug-piece and a connection piece and
wherein the plug piece and the connection piece are sealed against each other by a sealing ring disposed in an L-shaped sealing ring groove, and wherein the sealing ring together with a safety ring are inserted as a sealing unit into the L-shaped sealing ring groove in an axial direction, and beads are disposed in a region of a radial boundary wall of the L-shaped sealing groove, with the beads being spaced from each other in the peripheral direction and at least partially displacing the L-shaped sealing ring groove in a region of its axial opening so as to secure the safety ring on one axial side.

7. The plug connection according to claim 6, wherein the sealing ring is a profiled sealing ring with spread-apart lips that are springily elastic in the radial direction.

8. The plug connection according to claim 6, wherein the safety ring has a flat and approximately rectangular profile.

9. The plug connection according to claim 6, wherein pairs of different materials can be used for the plug piece and the safety ring.

10. The plug connection according to claim 6, wherein the safety ring is formed with complete rotational symmetry and does not include openings.

11. The plug connection according to claim 6, wherein the plug piece and/or the connection piece is/are formed with complete rotational symmetry.
